(19) United States
(12) Patent Application Publication
(10) Pub. No.: US 2025/0328549 A1
(43) Pub. Date: Oct. 23, 2025

(54) SYSTEMS AND METHODS OF GENERATING A RELATIONAL ATTRIBUTE NETWORK IN A STORAGE SYSTEM

(71) Applicant: Dell Products L.P., Round Rock, TX (US)

(72) Inventors: Sunil Gumaste, Bengaluru (IN); Thyagarajan Ramakrishnan, Bangalore (IN); Ramya Ramakrishnan, Bangalore (IN)

(73) Assignee: Dell Products L.P., Round Rock, TX (US)

(21) Appl. No.: 18/641,801

(22) Filed: Apr. 22, 2024

(51) Int. Cl. G06F 16/28

(52) U.S. Cl. CPC G06F 16/287

(57) ABSTRACT

Methods and systems providing a holistic approach to monitoring and maintaining a complex system, such as a distributed storage system, are disclosed. Telemetry data across a number of system components and their operational attributes is collected, structured and used to generate a correlation matrix. The collected attribute data includes data from within a given component and/or data obtained from other system components. The correlation matrix is used to generate a graph. The graph may include a plurality of nodes corresponding to the plurality of attributes and a plurality of edges corresponding to a correlation between at least two nodes. From the graph, relations between the components and their attributes are defined and examined in the context of a failure or system change. An interface may be provided allowing a user, such as an engineer or technician, to query the graph, nodes and edges to examine the interrelation between system attributes.

### BACKGROUND

In a complex system, like a distributed storage system, multiple components work together to accomplish a number of tasks or functions. Each of these components have their own attributes and properties related to the operation of the individual component as well as the system as a whole. Many of these attributes are related to other attributes, both within the same component and other system components. Due to the complexity of the system, when a failure or outage occurs, it is difficult to ascertain the reason for the failure and develop a comprehensive fix to the problem unless the system can be viewed in a holistic manner in which relationships between the attributes are examined and analyzed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect a computer-implemented method may include receiving telemetry data from one or more system components. The telemetry data may include a plurality of values associated with a plurality of attributes. The telemetry data may be stored in a data structure according to the plurality of attributes. A correlation matrix may be generated from the data structure. A graph may be generated from the correlation matrix. The graph may include a plurality of nodes corresponding to the plurality of attributes and a plurality of edges corresponding to a correlation between at least two nodes of the plurality of nodes.

The method may include, alone or in combination, one or more of the following features. The one or more system components may include a first component and a second component. The generation of the graph may include identifying a relationship between a first attribute of the first component and a second attribute of the first component or the second component. The generation of the graph may include identifying an indirect relationship between a first attribute and a second attribute. A first node of the plurality of nodes corresponding to the first attribute and a second node of the plurality of nodes corresponding to the second attribute may be connected by at least two edges. The graph may be stored in a database and a query interface may be provided and configured to receive a user query relating to at least one of the plurality of attributes. A list of related components may be generated in response to the user query. A response to the user query may be generated indicating the correlation between the at least two nodes. The user query may include a prospective system change and the response may include a list of affected attributes related to the prospective system change. The one or more system components may comprise a complex system. The complex system may comprise a distributed storage system. The telemetry data may be further stored in the data structure according to an event time.

According to another aspect, a system may comprise a memory and at least one processor that is operatively coupled to the memory. The at least one processor may be configured to perform the operations of receiving telemetry data from one or more system components. The telemetry data may include a plurality of values associated with a plurality of attributes. The telemetry data may be stored in a data structure according to the plurality of attributes. A correlation matrix may be generated from the data structure. A graph may be generated from the correlation matrix. The graph may include a plurality of nodes corresponding to the plurality of attributes and a plurality of edges corresponding to a correlation between at least two nodes of the plurality of nodes.

The system may include, alone or in combination, one or more of the following features. The one or more system components may include a first component and a second component. The generation of the graph may include identifying a relationship between a first attribute of the first component and a second attribute of the first component or the second component. The generation of the graph may include identifying an indirect relationship between a first attribute and a second attribute. A first node of the plurality of nodes corresponding to the first attribute and a second node of the plurality of nodes corresponding to the second attribute may be connected by at least two edges. The graph may be stored in a database and a query interface may be provided and configured to receive a user query relating to at least one of the plurality of attributes. A list of related components may be generated in response to the user query. A response to the user query may be generated indicating the correlation between the at least two nodes. The user query may include a prospective system change and the response may include a list of affected attributes related to the prospective system change. The one or more system components may comprise a complex system. The complex system may comprise a distributed storage system.

According to another aspect, a non-transitory computer-readable medium storing one or more processor-executable instructions, which when executed by at least one processor may cause the at least one processor to perform the operations of receiving telemetry data from one or more system components. The telemetry data may include a plurality of values associated with a plurality of attributes. The telemetry data may be stored in a data structure according to the plurality of attributes. A correlation matrix may be generated from the data structure. A graph may be generated from the correlation matrix. The graph may include a plurality of nodes corresponding to the plurality of attributes and a plurality of edges corresponding to a correlation between at least two nodes of the plurality of nodes.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a block diagram of a complex system, according to aspects of the present disclosure;

FIG. 2 is a flow diagram of workflow for a relational attribute network analytics system, according to aspects of the present disclosure;

FIG. 3A is an example of a data structure, according to aspects of the present disclosure;

FIG. 3B is an example of a correlation matrix, according to aspects of the present disclosure;

FIG. 4 is an example of a graph of a correlation network, according to aspects of the present disclosure;

FIG. 5 is a method of analyzing a relational attribute network, according to aspects of the present disclosure;

FIG. 6 is a diagram of an example of a storage system, according to one or more aspects of the present disclosure; and

FIG. 7 is a diagram of an example of a computing device, according to one or more aspects of the present disclosure.

### DETAILED DESCRIPTION

Aspects of the present disclosure include methods and systems for providing a holistic approach to monitoring and maintaining a complex system, such as a distributed storage system. Telemetry data across a number of system components and their operational attributes is collected, structured and used to generate a correlation matrix. The collected attribute data may include data from within a given component and/or data obtained from other system components working in conjunction with the given component. The correlation matrix may be used to generate a graph. The graph may include a plurality of nodes corresponding to the plurality of attributes and a plurality of edges corresponding to a correlation between at least two nodes of the plurality of nodes. From the graph, relationships between the components and their attributes may be defined and examined in the context of a failure or system change. The graph may provide insights as to the correlation between the attributes of the system. An interface may be provided allowing a user, such as an engineer or technician, to query the system to troubleshoot a problem. Additionally, the interface may be used to query the implications of a potential change to the system to determine how other system components and their attributes may be affected.

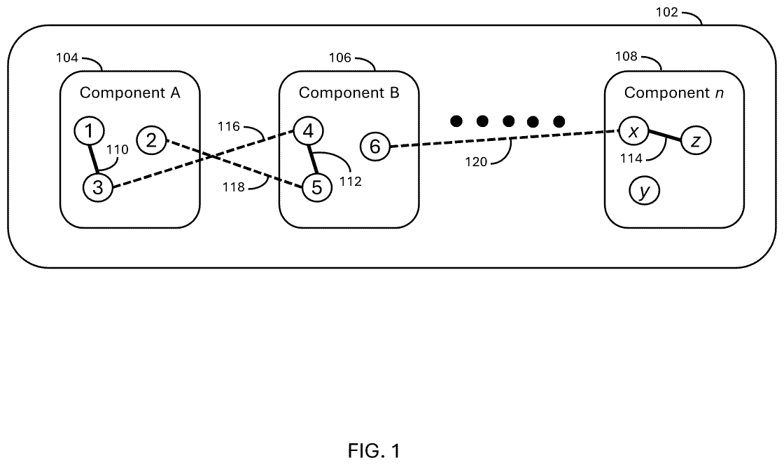

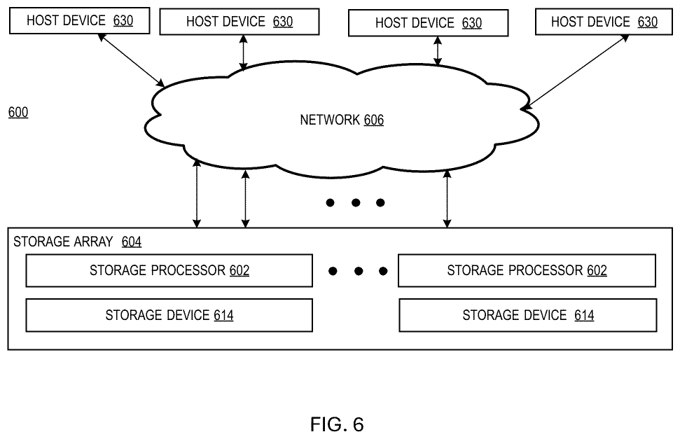

FIG. 1 is a block diagram of a complex system 102, according to aspects of the present disclosure. The system 102 may include or be defined by a number of components working in conjunction to accomplish one or more objectives. For example, and described herein, a complex system may be a distributed storage system, like that shown in FIG. 6. As shown in FIG. 1, the system 102 may include a number of components, such as Component A 104 and Component B 106 through Component n 108. Information regarding the operation of each component may be derived from multiple attributes. Each component may include or define one or more attributes related to the operation and function of the component.

According to one aspect, the attributes of a component may be related to other attributes of the component and/or other components. As used herein, an intra-component relation may be used to describe a relation between one or more attributes of the same component. An inter-component relation, as used herein, may indicate a relation between an attribute of a first component and one or more attributes of a second component. In the exemplary system 102 of FIG. 1, Component A may include attributes 1, 2, and 3. In operation, a change in attribute 1 may result in a corresponding change in attributes, as indicated by the solid line 110. Similarly, a change in attribute 3 of Component A 104 may result in a corresponding change in attribute 4 of Component B 106, shown by the dotted line 116. As shown in FIG. 1, dotted lines 110, 112, 114 may indicate inter-component relations, while the dotted lines 116, 118, 120 may indicate intra-component relations.

When one component in the system experiences an outage or failure, determining the reason for the failure can be difficult given the complexity of the system. For example, a piece of hardware may fail for a multitude of reasons, some of which may be directly tied to the hardware itself. However, system components can often fail as a result of some event occurring on a related component. If the relationship between the components, and their operational attributes are unknown, it may be difficult to identify the source of the problem and also provide a comprehensive fix. For example, the failing hardware may be replaced, however, if the cause of the failure originated in a separate component, changing out the hardware will not solve the problem and the failure may be likely to occur again.

Traditional methods of identifying the source of a problem in a complex system may rely heavily on root cause analysis (RCA) and subject matter expertise (SME). In the context of the system 102, if a failure occurs on Component A 104, RCA and SME methodologies may consider the data captured for local attributes 1, 2. These methodologies may also consider the relation between attribute 1 and attribute 2 to determine if there is a causal or a correlated effect. While an engineer or technician may have some level of expertise, that expertise may be limited in knowledge and/or availability. For example, there may be a correlated effect been attribute 3 of Component A 103 and attribute 4 of Component B 106. Traditional RCA and SME methodologies may not examine the inter-component relation between attributes of different components because the subject matter expert may not know of the correlation between seemingly unrelated attributes of separate components.

Similarly, defect triaging with different stakeholders in the system may also be limited in knowledge and can be time consuming. Other troubleshooting methods, like clustering, also present challenges. Clustering may only be useful in grouping similarly behaving components. Additionally, the resulting clusters may require further analysis to establish the relationships between component attributes.

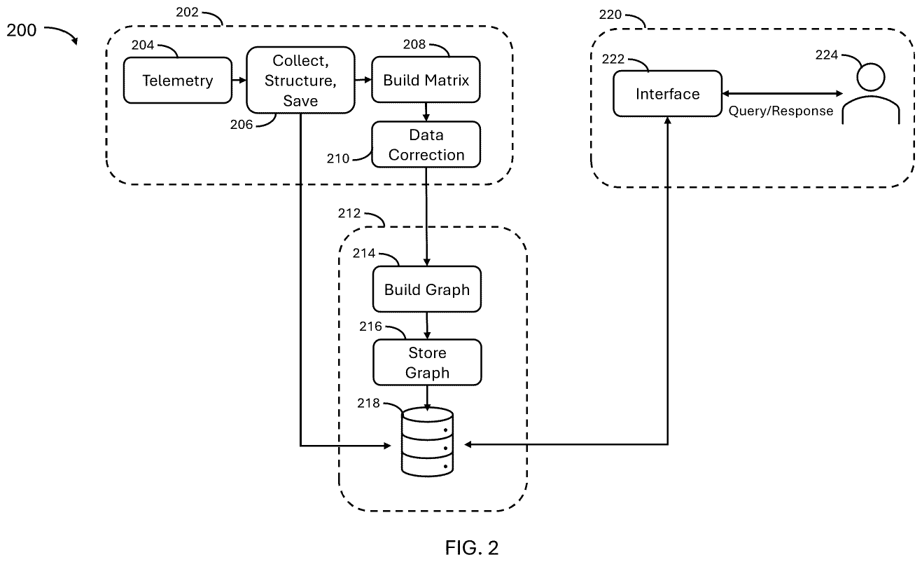

FIG. 2 is a flow diagram of workflow 200 for a relational attribute network analytics system, according to aspects of the present disclosure. The workflow 200 may include or be defined according to three phases. A first phase 202 may include collecting and structuring the operational system information. A second phase 212 may include the analysis of the system information from the first phase 202. A third phase 220 may include a practical application and interface for a user to query the system to examine the identified relations between various attributes and components of the system.

According to one aspect, the first phase 202 includes the data collection and structuring functions to prepare the data for analysis. As shown in block 204, telemetry data (e.g., data automatically measured, recorded and transmitted to a remote location for monitoring and analysis) may be collected locally and transmitted to another location for analysis. In a complex storage system, telemetry data may include, for example and without limitation, input/output (I/O) per second (IOPS), response rates, request rates, request latency rates, outgoing byte rates, average I/O wait time, page cache reads ratios, disk usage, central processing unit (CPU) usage, memory utilization, network bytes sent, network bytes received, and the like.

As shown in block 206, the telemetry data may be collected, structured and saved in a location where it may be analyzed and monitored. The data may be collected from the system components in real-time as system events occur, on a periodic basis according to a predetermined period, and/or in response to a failure or outage, any of which may trigger a dump of attribute data and subsequent transmission from the components. Once collected at the system, the data may be formatted and saved, in a database 218 or other memory, into a data structure suitable for and inputting to a matrix builder. The data structure may be a time-ordered table or the like. A matrix builder may receive the saved and structured data, as shown in block 208, to build a correlation matrix that captures and quantifies a potential correlation between any two or more of the input attributes. As shown in block 210, the correlation matrix data may be analyzed and corrected to account for any spurious or outlier data.

With the correlation matrix corrected, the workflow 200 may enter the second phase 212. As shown in block 214, the correlation matrix may be used to build a correlation-network graph. As described herein the graph may include nodes representing the various attributes of the system components. Edges connecting two nodes in the graph may represent a correlation between the nodes. According to one aspect, as described herein, graph edges may be generated linking attributes that are inter-related as well as intra-related. Thereby providing a practical insight as to potential cause and effect or correlated dependencies on a system-wide level. The graph may be stored in the database 218, or other memory, as shown in block 216.

The third phase 220 of the workflow 200 may include the practical application of monitoring and reviewing the graph for impacts to the system when one or more attributes change. Accordingly, an interface 222 may provide a mechanism for a user 224, such as an engineer or technician, an application to query the database 218 and in response, receive a graph including queried information in the form of related attributes linked across the system.

According to one aspect, the user 222 may query the system in response to a failure or outage in a first component to troubleshoot the issue. The user 222 may be looking for data related to the failure by examining attributes identified as related in the graph. Nodes in the graph linked by an edge may indicate a correlation such that the failure may be traced back to its origin by examining related attributes within the first component as well as other components and their attributes. The system may provide a holistic view of the system to allow identification of potential sources of the failure such that a user 222 may efficiently and effectively troubleshoot and fix system.

According to one aspect, the third phase 220 may provide the user 222 the ability to proactively assess a potential change to a component within the system and whether that change may affect other attributes or other components. For example, in response to a query relating to a first attribute, the system may generate and provide a graph indicating a relation to another attribute or component that, if the first attribute is changed (i.e., a component or setting change), the related attributes on the graph, whether on the same component or a different one, may be affected, potentially in a negative manner. Accordingly, the user 222 may alter or abandon the potential change so as to not negatively impact the system.

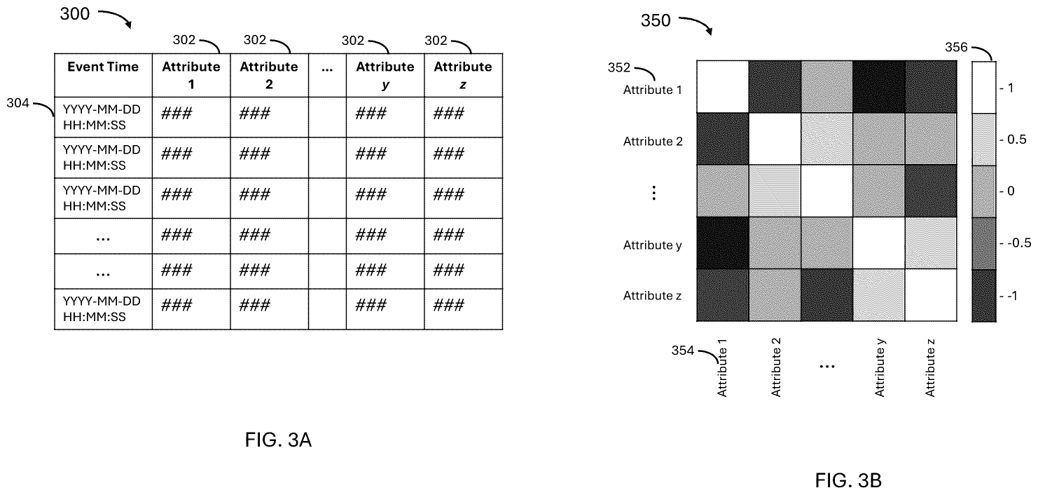

FIG. 3A is an example of a data structure 300, according to aspects of the present disclosure. The data structure 300 may include a table-like format whereby attribute data 302 related to events may be ordered according to an event time 304 or other timestamp. Accordingly, at each event time 304 the structure may include values for each attribute (Attribute 1-Attribute z) captured. The data structure 300 may be input to a matrix builder to generate a correlation matrix reflecting a level of correlation between the attributes over time.

FIG. 3B is an example of a correlation matrix 350, according to aspects of the present disclosure. The correlation matrix 350 may reflect potential relations between attributes, shown as attribute rows 352 and attribute columns 354. A correlation scale 356 may indicate a level of correlation between the attributes. A 1:1 correlation, for example an attributes correlation with itself, may be given a value of ‘1’. According to one aspect, a positive correlation may be given if two attributes change in the same manner (e.g., positive or negative), such as while a negative correlation may be given if the two attributes change in an opposing manner (e.g. one attribute increases, while the other decreases). If one attribute changes and a second attribute has not changed, a zero correlation may be given. While the correlation matrix 350 shown in FIG. 3B includes 5 correlation levels or ratings, one skilled in the art will recognize that the correlation scale 356 may include correlation levels of any granularity or scale.

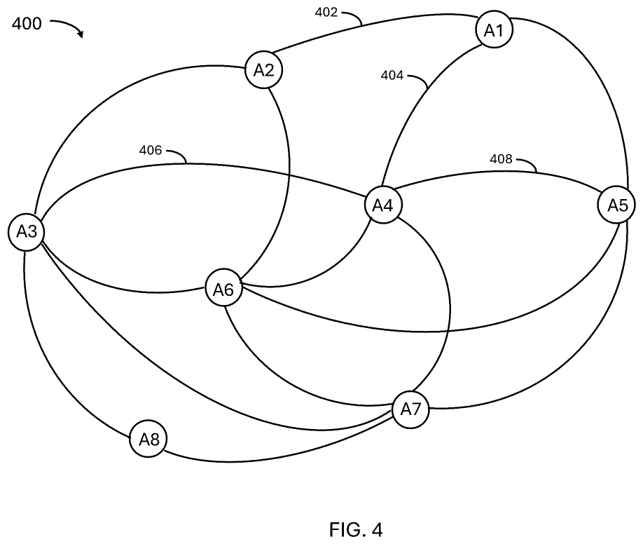

FIG. 4 is an example of a graph 400 of a correlation network, according to aspects of the present disclosure. The graph 400 may represent a spider-web-like structure which may indicate changes in any component or attribute cascading through to affect the related components or attributes. The exemplary graph 400 includes eight attributes (A1-A8) linked by one or more edges denoting a correlated relation based on a correlation matrix generated by the concepts and techniques described herein. According to one aspect, certain relations between two attributes may be known. For example, it may be known or well recognized that a change in attribute A1 may have a direct effect on attribute A2, reflected by edge 402, and a direct effect on attribute A4, reflected by edge 404.

Conversely, it may not be readily apparent that an attribute, like attribute A3, has a direct correlation with attribute A4, or that attribute A5 also has a direct correlation with attribute A4. The graph 400, however, may reflect, based on the generated correlation matrix, that indeed those attributes are correlated and a change in one of those attributes may result in a change in the other attribute. Similarly, graph 400 also indicates potential indirect relations between attributes. For example, attribute A3, while not directly linked to attribute A5, is linked indirectly through edges 406 and 408. As such, a change in attribute A3 may have an indirect impact on attribute A5, or vice versa (i.e., a change in attribute A5 may have an indirect impact on attribute A3).

In a complex storage system, for example, attribute A1 may include a “drive health” metric, attribute A2 may include a “power cycle” metric, attribute A3 may include a “drive temperature” metric, attribute A4 may include an “unsafe shutdown” metric, and attribute A5 may include a “media error” metric. Accordingly, it may be readily known that an attribute like “unsafe shutdown” (attribute A4) may impact the “power cycle” (attribute A2) and “drive health” (attribute A1) metrics. It may not be readily apparent, however, that “unsafe shutdown” (attribute A4) may directly impact “media errors” (attribute A5) or that “unsafe shutdown” (attribute A4) may directly impact “drive temperature” (attribute A5). The graph 400 may provide the necessary insight to inform a user that events occurring in these attributes have effects on attributes and components not previously known. The graph 400 may also indicate indirect relations as well. For example, the graph may indicate, through edges 406 and 408, that the “drive temperature” (attribute A3) may have a previously unknown indirect correlation with the “media error” metric (attribute A5).

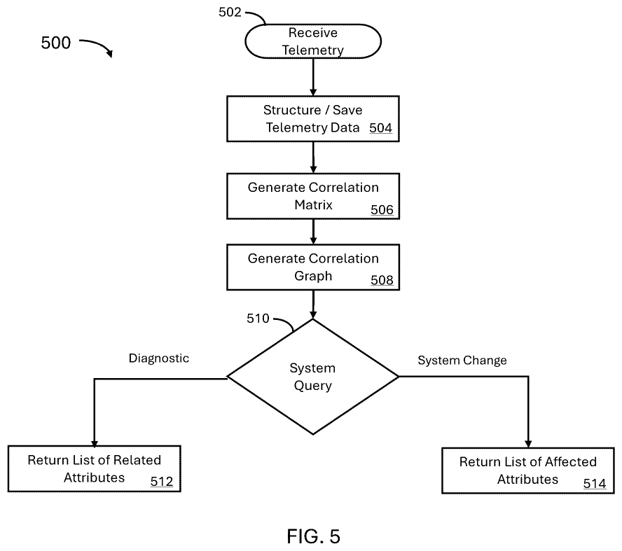

FIG. 5 is a method 500 of analyzing a relational attribute network, according to aspects of the present disclosure. As described herein, and shown in block 502, a relational attribute network analytics system may receive telemetry data from one or more components of a complex system. The telemetry data may be transmitted, collected and/or received in real-time or it may be received on a periodic basis according to a predetermined time frame. As shown on block 504, the system may structure and save the telemetry data, as described herein, in an appropriate format for inputting to a matrix builder. As shown in block 506, the structured data may be used to generate a correlation matrix. According to one aspect, the correlation matrix may be generated using the functions and libraries of a programming language, such as Python, or the like.

According to one aspect, as shown in block 508, the correlation matrix may be used to generate a correlation network graph, as described herein. The nodes of the graph may represent component attributes and the edges linking the nodes may represent a correlation between changes to the respective attributes. The graph may reflect relations and impacts between attributes of the same component or attributes of other components within the system. Accordingly, changes to the attribute data of a first attribute may be considered to impact, or have a correlation with, the data from another attribute.

As shown in block 510, a query to the system may include a diagnostic query or a system change query. A diagnostic query may be in response to a system event, such as a failure or outage, to which a user may be investigating. Querying the system may return a list of related attributes in the form of a graph, as shown in block 512. The user may investigate and analyze the functions and operation of related attributes and components as indicated in the graph. According to another aspect, a system change query may include a request identifying a component or attribute for a prospective change, for example changing a component hardware, setting or other operational parameter. As shown in block 514, the system may return a list of affected attributes and components in the form of a graph. Edges connecting the attribute nodes of the graph may indicate a change to one attribute may have an impact on one or more connected attributes.

FIG. 6A is a diagram of an example of a storage system 600, according to aspects of the disclosure. According to one aspect, the storage system 600 may be or include a complex system to be monitored and analyzed by a relational attribute network analytics system. As illustrated, the system 600 may include a storage array 604, a communications network 606, and a plurality of host devices 630. The communications network 606 may include one or more of a fibre channel (FC) network, the Internet, a local area network (LAN), a wide area network (WAN), and/or any other suitable type of network. The storage array 604 may include a storage system, such as DELL/EMC Powermax™, DELL PowerStore™, and/or any other suitable type of storage system. The storage array 604 may include or be arranged with one or more node-pairs and a plurality of non-volatile memory storage devices 614. Each node of the node pairs may include one or more storage processors 602. Each of the storage processors 602 may be configured to receive Input/Output (I/O) requests from host devices 630 and execute the received I/O requests by reading and/or writing data to storage devices 614. Each of the host devices 630 may include a desktop computer, a laptop, a smartphone, an internet-of-things (IoT) device, and/or any other suitable type of computing device.

According to one aspect, each of storage devices 614 may be a non-volatile memory express (NVMe) drive. In another aspect, the storage devices may be solid-state drives (SSD). In some implementations, each of the storage devices 614 may be connected to the storage processors 602 via a Peripheral Component Interconnect Express (PCIe) connection. Each of the storage devices 614 may include a respective controller (not shown) and storage medium (not shown). The controller of each storage device 614 may include processing circuitry that is configured to perform various tasks, such as the retrieval and storage of data on the medium, wear leveling, error handling, garbage collection, as well as other functions. The medium may include an array of NAND memory cells and/or any other suitable type of storage medium.

In some implementations, any of the storage devices 614 may be internal to one of the storage processors 602 and coupled to the storage processor via an M.2 slot that is provided on the motherboard of that storage processor. Additionally, or alternatively, in some implementations, any of the storage devices 614 may be part of a disk array enclosure (DAE) and coupled to each of the storage processors 602 via a respective InfiniBand adapter of that storage processor. It will be understood that the present disclosure is not limited to any specific

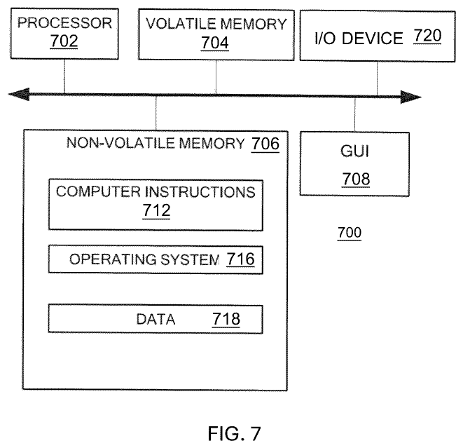

Referring to FIG. 7, in some embodiments, a computing device 700 may include processor 702, volatile memory 704 (e.g., RAM), non-volatile memory 706 (e.g., a hard disk drive, a solid-state drive such as a flash drive, a hybrid magnetic and solid-state drive, etc.), graphical user interface (GUI) 708 (e.g., a touchscreen, a display, and so forth) and input/output (I/O) device 720 (e.g., a mouse, a keyboard, etc.). Non-volatile memory 706 stores computer instructions 712, an operating system 716 and data 718 such that, for example, the computer instructions 712 are executed by the processor 702 out of volatile memory 704. Program code may be applied to data entered using an input device of GUI 708 or received from I/O device 720.

FIGS. 1-7 are provided as an example only. In some aspects or embodiments, the term “I/O request” or simply “I/O” may be used to refer to an input or output request. In some embodiments, an I/O request may refer to a data read or write request. At least some of the steps discussed with respect to FIGS. 1-7 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A computer-implemented method comprising:
receiving telemetry data from one or more system components, the telemetry data including a plurality of values associated with a plurality of attributes;
storing the telemetry data in a data structure according to the plurality of attributes;
generating a correlation matrix from the data structure reflecting one or more relations between each of the plurality of attributes; and
generating a correlation network graph from the correlation matrix, the graph including a plurality of nodes corresponding to the plurality of attributes and a plurality of edges corresponding to a correlation between at least two nodes of the plurality of nodes.

2. The method of claim 1 wherein the one or more system components includes a first component and a second component, wherein generating the graph includes identifying a relationship between a first attribute of the first component and a second attribute of the first component or second component.

3. The method of claim 1 wherein generating the graph includes identifying an indirect relationship between a first attribute and a second attribute, wherein a first node of the plurality of nodes corresponding to the first attribute and a second node of the plurality of nodes corresponding to the second attribute are connected by at least two edges.

4. The method of claim 1 further comprising storing the graph in a database and providing a query interface configured to receive a user query relating to at least one of the plurality of attributes.

5. The method of claim 4 comprising generating a list of related components in response to the user query.

6. The method of claim 4 further comprising providing a response to the user query indicating the correlation between the at least two nodes.

7. The method of claim 6 wherein the user query includes a prospective system change and the response includes a list of affected attributes related to the prospective system change.

8. The method of claim 1 wherein the one or more system components comprises a complex system.

9. The method of claim 8 wherein the complex system comprises a distributed storage system.

10. The method of claim 1 wherein the telemetry data is further stored in the data structure according to an event time.

11. A system comprising:
a memory; and
at least one processor that is operatively coupled to the memory, the at least one processor being configured to perform the operations of:
receiving telemetry data from a one or more system components, the telemetry data including a plurality of values associated with a plurality of attributes;
storing the telemetry data in a data structure according to the plurality of attributes;
generating a correlation matrix from the data structure reflecting one or more relations between each of the plurality of attributes; and
generating a correlation network graph from the correlation matrix, the graph including a plurality of nodes corresponding to the plurality of attributes and a plurality of edges corresponding to a correlation between at least two nodes of the plurality of nodes.

12. The system of claim 11 wherein the one or more system components includes a first component and a second component, wherein generating the graph includes identifying a relationship between a first attribute of the first component and a second attribute of the first component or second component.

13. The system of claim 11 wherein generating the graph includes identifying an indirect relationship between a first attribute and a second attribute, wherein a first node of the plurality of nodes corresponding to the first attribute and a second node of the plurality of nodes corresponding to the second attribute are connected by at least two edges.

14. The system of claim 11 further comprising storing the graph in a database and providing a query interface configured to receive a user query relating to at least one of the plurality of attributes.

15. The system of claim 14 comprising generating a list of related components in response to the user query.

16. The system of claim 14 further comprising providing a response to the user query indicating the correlation between the at least two nodes.

17. The system of claim 16 wherein the user query includes a prospective system change and the response includes a list of affected attributes related to the prospective system change.

18. The system of claim 11 wherein the one or more system components comprises a complex system.

19. The system of claim 18 wherein the complex system comprises a distributed storage system.

20. A non-transitory computer-readable medium storing one or more processor-executable instructions, which when executed by at least one processor cause the at least one processor to perform the operations of:
receiving telemetry data from a system, the telemetry data including a plurality of values associated with a plurality of attributes;
storing the telemetry data in a data structure according to the plurality of attributes;
generating a correlation matrix from the data structure reflecting one or more relations between each of the plurality of attributes; and
generating a correlation network graph from the correlation matrix, the graph including a plurality of nodes corresponding to the plurality of attributes and a plurality of edges corresponding to a correlation between at least two nodes of the plurality of nodes.
